(19) United States
(12) Patent Application Publication
(10) Pub. No.: US 2025/0113278 A1
(43) Pub. Date: Apr. 3, 2025

(54) RADIO LINK MONITORING IN MULTIPLE TRANSMITTER RECEIVER POINT SCENARIO

(71) Applicant: Nokia Technologies Oy, Espoo (FI)

(72) Inventors: Subramanya CHANDRASHEKAR, Bangalore (IN); Srinivasan SELVAGANAPATHY, Bangalore (IN); Tero HENTTONEN, Espoo (FI); Guillaume DECARREAU, Munich (DE)

(21) Appl. No.: 18/834,515

(22) PCT Filed: Feb. 3, 2022
(86) PCT No.: PCT/EP2022/052608

§ 371 Date: Jul. 30, 2024

(51) Int. Cl. H04W 36/30; H04B 17/318; H04W 24/08; H04W 24/10

(52) U.S. Cl. CPC H04W 36/302; H04B 17/328; H04W 24/08; H04W 24/10

(57) ABSTRACT

The present disclosure relates to techniques that enable an efficient Radio Link Monitoring (RLM) for a User Equipment (UE) in a multi Transmitter Receiver Point (mTRP) scenario. For this purpose, a serving cell of a serving Distributed Unit (DU) of a disaggregated network node and at least one non-serving (or stand-by) cell of a non-serving DU of the disaggregated network node are configured fora UE. Then, the UE is informed of beams used for the serving and non-serving cells. The UE performs the RLM over the serving cell by using the beams of the serving cell. Whenever there is an Radio Link (RL) quality degradation (which may potentially lead to an RL Failure (RLF)) detected in the serving cell, the UE may initiate switching of the RLM from the serving cell to one of the non-serving cells by transmitting a corresponding request to the serving DU.

### TECHNICAL FIELD

The present disclosure relates generally to the field of wireless communications, and particularly to apparatuses, methods, and computer readable mediums for performing Radio Link Monitoring (RLM) in a multiple Transmitter Receiver Point (mTRP) scenario.

### BACKGROUND

As defined in the 3GPP, a disaggregated gNB architecture implies that a gNB is decomposed into multiple logical entities, such as one or more Distributed Units (DUs) and a Centralized Unit (CU). A single DU may host multiple cells (up to 512). A CU-Control Plane (CP) (CU-CP) part hosts Packet Data Convergence Protocol (PDCP) and Radio Resource Control (RRC) layers, while the DU hosts Radio Link Control (RLC), Media Access Control (MAC, also referred to as Layer 2 or L2) and Physical Layer (PHY, also referred to as Layer 1 or L1) layers. A scheduling operation also takes place at the DU.

There is an ongoing Release 17 RAN1-led NR_feMIMO work item in the 3GPP (expected to impact all of RAN1-4 working groups), which extends mTRP operation to support transmission and reception of multiple beams from different cells, with limitation that these cells must belong to the same DU (i.e., the so-called intra-DU mTRP operation). A potential change of a serving cell to a new cell via L1/L2-based mechanisms is outside the scope of Release 17.

Although 3GPP Release 17 is limited to the intra-DU mTRP operation, there is a significant operator and vendor demand to continue further work in Release 18 with a broader scope, which is likely to be agreed as well. This would include support also for the change of the serving cell to a new cell via the L1/L2-based mechanisms in both the intra-DU and inter-DU scenarios.

To support such L1/L2-centric inter-cell change in the disaggregated gNB architecture, a new mechanism is needed, in which configuration would take place at the CU-CP but would be executed autonomously by the DU without further interaction with the upper layers.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables efficient RLM for a UE in a mTRP scenario.

The objective above is achieved by the features of the independent claims in the appended claims. Further embodiments and examples are apparent from the dependent claims, the detailed description and the accompanying drawings.

According to a first aspect, a UE in a wireless communication network is provided. The UE comprises at least one processor and at least one memory. The at least one memory comprises a computer program code. The at least one memory and the computer program code are configured to, with the at least one processor, cause the UE to operate at least as follows. At first, the UE is caused to receive, from a Centralized Unit (CU) of a network node, configuration information indicative of: (i) at least one beam corresponding to a serving cell of a serving Distributed Unit (DU) of the network node, (ii) at least one beam corresponding to at least one non-serving cell of a non-serving DU of the network node. Further, the UE is caused to perform Radio Link Monitoring (RLM) over the serving cell by using the at least one beam of the serving cell. During the RLM, the UE is caused to detect that there is a Radio Link (RL) quality degradation occurred in the serving cell. The UE is then caused to transmit, to the serving DU, a request for switching the RLM from the serving cell to one of the at least one non-serving cell. The request comprises a signal measurement and an RLM report relating to the RL quality degradation. Next, the UE is caused to receive a response from the serving DU. The response is indicative of a target cell among the at least one non-serving cell. The UE is then caused to switch the RLM from the serving cell to the target cell. By so doing, the UE may efficiently perform switching of the RLM from the serving cell to a new (previously non-serving or stand-by) cell whenever there is an impending RL Failure (RLF) detected in the serving cell. The proposed UE operation is very efficient, particularly when the non-serving cell(s) is(are) configured as part of Inter-Cell Beam Management (ICBM) operation for UEs configured with lower layer mobility.

In one example embodiment of the first aspect, the configuration information is further indicative of an RLM switching timer. In this embodiment, the at least one memory and the computer program code are further configured to, with the at least one processor, cause the UE to trigger the RLM switching timer upon detecting the RL quality degradation in the serving cell and transmit the request to the serving DU after the RLM switching timer expires. By using the RLM switching timer, it is possible to promptly inform the serving DU of the RL quality degradation (which may potentially lead to RLF) in the serving cell.

In one example embodiment of the first aspect, the RLM switching timer is part of a T310 timer. The T310 timer is one of the known 5th Generation (5G) New Radio (NR) timers, which means that the UE may be adapted to efficiently perform the RLM in 5G NR systems.

In one example embodiment of the first aspect, the at least one memory and the computer program code are configured to, with the at least one processor, cause the UE to transmit the request by using at least one of Medium Access Control (MAC) Control Element (CE) and a Channel State Information (CSI) report. By so doing, the UE may use the already existing message type(s), without having to create new ones. This may make the UE applicable in the current communication systems (e.g., 5G NR systems).

In one example embodiment of the first aspect, the at least one memory and the computer program code are configured to, with the at least one processor, cause the UE to transmit the request by using a Layer 1 (L1) or Layer 2 (L2)-based mechanism. Thus, the UE may be adapted to efficiently perform the RLM via the L1 or L2-based mechanism.

In one example embodiment of the first aspect, the signal measurement comprises at least one of a Reference Signals Received Power (RSRP) and/or a Reference Signal Received Quality (RSRQ). By using these parameters, it is possible to select the suitable target cell for RLF monitoring for the UE when there is an RL quality degradation (or an RLF predicted) in the serving cell.

According a second aspect, a CU of a network node is provided. The network node is disaggregated in a wireless communication network into a serving DU, a non-serving DU and the CU. The CU comprises at least one processor and at least one memory. The at least one memory comprises a computer program code. The at least one memory and the computer program code are configured to, with the at least one processor, cause the CU to operate at least as follows. At first, the CU is caused to generate configuration information indicative of: (i) at least one beam corresponding to a serving cell of the serving DU of the network node, (ii) at least one beam corresponding to at least one non-serving cell of the non-serving DU of the network node. The CU is then caused to transmit the configuration information to a UE. After that, the CU is caused to generate a criterion for the serving DU to select a target cell among the at least one non-serving cell. The criterion is used if the serving DU receives a request for switching RLM from the serving cell to one of the at least one non-serving cell from the UE. Next, the CU is caused to transmit the criterion to the serving DU. By so doing, the CU may facilitate efficient RLM for the UE in both intra-DU and inter-DU scenarios, as well as allow the serving DU to efficiently select a new (previously non-serving or stand-by) in response to an RL quality degradation (e.g., potential RLF) occurred in the serving cell. The latter may in turn allow the UE to efficiently perform switching of the RLM from the serving cell to such a new cell whenever there is an impending RLF detected in the serving cell.

In one example embodiment of the second aspect, the configuration information is further indicative of an RLM switching timer to be used by the UE when an RL quality degradation occurs in the serving cell of the serving DU. By using the RLM switching timer, the UE may promptly inform the serving DU of the RL quality degradation (which may potentially lead to an RLF) in the serving cell.

In one example embodiment of the second aspect, the RLM switching timer is part of a T310 timer. The T310 timer is one of the known 5G NR timers, which means that the CU may be integrated into 5G NR systems.

In one example embodiment of the second aspect, the criterion is defined as follows: an RL quality indicator (e.g., an RSRP) for the target cell is above a threshold. By using this criterion, it is possible to select the most suitable target cell among the non-serving cells.

According to a third aspect, a serving DU of a network node is provided. The network is disaggregated in a wireless communication network into the serving DU, a non-serving DU and a CU. The serving DU comprises at least one processor and at least one memory. The at least one memory comprises a computer program code. The at least one memory and the computer program code are configured to, with the at least one processor, cause the serving DU to operate at least as follows. At first, the serving DU is caused to receive, from a UE, a request for switching RLM from a serving cell of the serving DU to one of at least one non-serving cell of the non-serving DU. The request comprises a signal measurement and an RLM report relating to an RL quality degradation occurred in the serving cell of the serving DU. Then, the serving DU is caused to receive, from the CU, a criterion for selecting a target cell among the at least one non-serving cell. After that, the serving DU is caused to use the request and the criterion to select the target cell among the at least one non-serving cell. Next, the serving DU is caused to transmit a response indicative of the target cell to the UE. By so doing, the serving DU may allow the UE to efficiently perform switching of the RLM from the serving cell to a new (previously non-serving or stand-by) cell whenever there is an impending RLF detected in the serving cell.

In one example embodiment of the third aspect, the at least one memory and the computer program code are configured to, with the at least one processor, cause the serving DU to transmit the response by using a MAC CE. By so doing, the serving DU may use the already existing message type, without having to create a new one. This may make the serving DU applicable in the current communication systems (e.g., 5G NR systems).

In one example embodiment of the third aspect, the at least one memory and the computer program code are configured to, with the at least one processor, cause the serving DU to receive the request by using a L1-based or L2-based mechanism. Thus, the serving DU may be adapted to efficiently communicate with the UE via the L1 or L2-based mechanism.

In one example embodiment of the third aspect, the signal measurement comprises at least one of a RSRP and a RSRQ. By using these parameters, the serving DU may select the suitable target cell for the UE in response the RL quality degradation (or potential RLF) detected in the serving cell.

In one example embodiment of the third aspect, the criterion is defined as follows: an RL quality indicator (e.g., an RSRP) for the target cell is above a threshold. By using this criterion, the serving DU may select the most suitable target cell among the non-serving cells.

According to a fourth aspect, a method for operating a UE in a wireless communication network is provided. The method starts with the step of receiving, from a CU of a network node, configuration information indicative of: (i) at least one beam corresponding to a serving cell of a serving DU of the network node, (ii) at least one beam corresponding to at least one non-serving cell of a non-serving DU of the network node. The method then proceeds to the step of performing RLM over the serving cell by using the at least one beam of the serving cell. Next, during the RLM, the method goes on to the step of detecting that there is an RL quality degradation occurred in the serving cell. After that, the method proceeds to the step of transmitting, to the serving DU, a request for switching the RLM from the serving cell to one of the at least one non-serving cell. The request comprises a signal measurement and an RLM report relating to the RL quality degradation. The method subsequently proceeds to the steps of receiving, from the serving DU, a response indicative of a target cell among the at least one non-serving cell and switching the RLM from the serving cell to the target cell. By so doing, the UE may efficiently perform switching of the RLM from the serving cell to a new (previously non-serving or stand-by) cell whenever there is an impending RLF detected in the serving cell. The proposed UE operation is very efficient, particularly when the non-serving cell(s) is(are) configured as part of ICBM operation for UEs configured with lower layer mobility.

According to a fifth aspect, a method for operating a CU of a network node is provided. The network node is disaggregated in a wireless communication network into a serving DU, a non-serving DU and the CU. The method starts with the step of generating configuration information indicative of: (i) at least one beam corresponding to a serving cell of the serving DU of the network node, (ii) at least one beam corresponding to at least one non-serving cell of the non-serving DU of the network node. Then, the method proceeds to the step of transmitting the configuration information to a UE. Next, the method goes on to the step of generating a criterion for the serving DU to select a target cell among the at least one non-serving cell. The criterion is used if the serving DU receives a request for switching RLM from the serving cell to one of the at least one non-serving cell from the UE. After that, the method proceeds to the step of transmitting the criterion to the serving DU. By so doing, the CU may facilitate efficient RLM for the UE in both intra-DU and inter-DU scenarios, as well as allow the serving DU to efficiently select a new (previously non-serving or stand-by) in response to an RL quality degradation (which may potentially lead to an RLF) occurred in the serving cell. The latter may in turn allow the UE to efficiently perform switching of the RLM from the serving cell to such a new cell whenever there is an impending RLF detected in the serving cell.

According to a sixth aspect, a method for operating a serving DU of a network node is provided. The network node is disaggregated in a wireless communication network into the serving DU, a non-serving DU and a CU. The method starts with the step of receiving, from a UE, a request for switching RLM from a serving cell of the serving DU to one of at least one non-serving cell of the non-serving DU. The request comprises a signal measurement and an RLM report relating to an RL quality degradation occurred in the serving cell of the serving DU. Then, the method proceeds to the step of receiving, from the CU, a criterion for selecting a target cell among the at least one non-serving cell. Next, the method goes on to the step of using the request and the criterion to select the target cell among the at least one non-serving cell. After that, the method proceeds to the step of transmitting, to the UE, a response indicative of the target cell. By so doing, the serving DU may allow the UE to efficiently perform switching of the RLM from the serving cell to a new (previously non-serving or stand-by) cell whenever there is an impending RLF detected in the serving cell.

According to a seventh aspect, a computer program product is provided. The computer program product comprises a computer-readable storage medium that stores a computer code. Being executed by at least one processor, the computer code causes the at least one processor to perform the method according to the fourth aspect. By using such a computer program product, it is possible to simplify the implementation of the method according to the fourth aspect in any user device, like the UE according to the first aspect.

According to an eighth aspect, a computer program product is provided. The computer program product comprises a computer-readable storage medium that stores a computer code. Being executed by at least one processor, the computer code causes the at least one processor to perform the method according to the fifth aspect. By using such a computer program product, it is possible to simplify the implementation of the method according to the fifth aspect in any logical entity of a network node, like the CU according to the second aspect.

According to a ninth aspect, a computer program product is provided. The computer program product comprises a computer-readable storage medium that stores a computer code. Being executed by at least one processor, the computer code causes the at least one processor to perform the method according to the sixth aspect. By using such a computer program product, it is possible to simplify the implementation of the method according to the sixth aspect in any logical entity of a network node, like the serving DU according to the third aspect.

According to a tenth aspect, a UE in a wireless communication network is provided. The UE comprises a means for receiving, from a CU of a network node, configuration information indicative of: (i) at least one beam corresponding to a serving cell of a serving DU of the network node, (ii) at least one beam corresponding to at least one non-serving cell of a non-serving DU of the network node. The UE further comprises a means for performing RLM over the serving cell by using the at least one beam of the serving cell. The UE further comprises a means for detecting, during the RLM, that there is an RL quality degradation occurred in the serving cell. The UE further comprises a means for transmitting, to the serving DU, a request for switching the RLM from the serving cell to one of the at least one non-serving cell. The request comprises a signal measurement and an RLM report relating to the RL quality degradation. The UE further comprises a means for receiving a response from the serving DU. The response is indicative of a target cell among the at least one non-serving cell.

The UE further comprises a means for switching the RLM from the serving cell to the target cell. By so doing, the UE may efficiently perform switching of the RLM from the serving cell to a new (previously non-serving or stand-by) cell whenever there is an impending RLF detected in the serving cell. The proposed UE operation is very efficient, particularly when the non-serving cell(s) is(are) configured as part of ICBM operation for UEs configured with lower layer mobility.

According to an eleventh aspect, a CU of a network node is provided. The network node is disaggregated in a wireless communication network into a serving DU, a non-serving DU and the CU. The CU comprises a means for generating configuration information indicative of: (i) at least one beam corresponding to a serving cell of the serving DU of the network node, (ii) at least one beam corresponding to at least one non-serving cell of the non-serving DU of the network node. The CU further comprises a means for transmitting the configuration information to a UE. The CU further comprises a means for generating a criterion for the serving DU to select a target cell among the at least one non-serving cell. The criterion is used if the serving DU receives a request for switching RLM from the serving cell to one of the at least one non-serving cell from the UE. The CU further comprises a means for transmitting the criterion to the serving DU. By so doing, the CU may facilitate efficient RLM for the UE in both intra-DU and inter-DU scenarios, as well as allow the serving DU to efficiently select a new (previously non-serving or stand-by) in response to an RL quality degradation (which may potentially lead to an RLF) occurred in the serving cell. The latter may in turn allow the UE to efficiently perform switching of the RLM from the serving cell to such a new cell whenever there is an impending RLF detected in the serving cell.

According to a twelfth aspect, a serving DU of a network node is provided. The network is disaggregated in a wireless communication network into the serving DU, a non-serving DU and a CU. The serving DU comprises a means for receiving, from a UE, a request for switching RLM from a serving cell of the serving DU to one of at least one non-serving cell of the non-serving DU. The request comprises a signal measurement and an RLM report relating to an RL quality degradation occurred in the serving cell of the serving DU. The serving DU further comprises a means for receiving, from the CU, a criterion for selecting a target cell among the at least one non-serving cell. The serving DU further comprises a means for using the request and the criterion to select the target cell among the at least one non-serving cell. The serving DU further comprises a means for transmitting a response indicative of the target cell to the UE. By so doing, the serving DU may allow the UE to efficiently perform switching of the RLM from the serving cell to a new (previously non-serving or stand-by) cell whenever there is an impending RLF detected in the serving cell.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a disaggregated gNB architecture in accordance with one example embodiment;

FIG. 2 shows a block diagram of a User Equipment (UE) in accordance with one example embodiment;

FIG. 3 shows a flowchart of a method for operating the UE shown in FIG. 2 in accordance with one example embodiment;

FIG. 4 shows a block diagram of a Centralized Unit (CU) of a network node in accordance with one example embodiment;

FIG. 5 shows a flowchart of a method for operating the CU shown in FIG. 4 in accordance with one example embodiment;

FIG. 6 shows a block diagram of a serving Distributed Unit (DU) of the network node in accordance with one example embodiment;

FIG. 7 shows a flowchart of a method for operating the DU shown in FIG. 6 in accordance with one example embodiment;

FIG. 8 shows an interaction diagram that explains the interaction between a UE and logical entities of a disaggregated network node in accordance with one example embodiment; and

FIG. 9 shows an interaction diagram that explains the interaction between a UE and logical entities of a disaggregated network node in accordance with another example embodiment.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) (also known as a client device) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication for a UE in a particular wireless communication network. The network node may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

According to the example embodiments disclosed herein, a wireless communication network, in which a UE and a network node communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

It should be noted that the example embodiments disclosed herein are applicable to all (already existing or future) radio access technologies in which the network node may be implemented in a split or disaggregated architecture, with one or more first units providing functionality of one or more lower layers in a given protocol stack and a second unit providing functionality of one or more higher layers in the protocol stack. For example, such a disaggregated architecture is feasible for gNBs in 5G NR systems, for which the one or more first units may be represented by at least one distributed unit (DU) and the second unit may be represented by a centralized unit (CU). The CU may be further split into a CU Control Plane (CP) part, also referred to as CU-C or CU-CP, and a CU User Plane (UP) part, also referred to as CU-U or CU-UP. Such split enables the implementation of the CU-CP and CU-UP parts in different locations. Another additional split option is the lower layer split, which may be applied to the at least one DU.

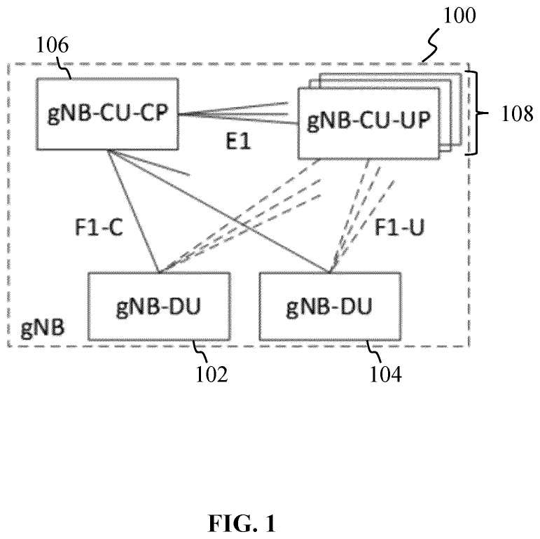

FIG. 1 shows a block diagram of a disaggregated gNB architecture in accordance with one example embodiment. In the shown disaggregated gNB architecture, a gNB 100 is disaggregated into two gNB-DUs 102 and 104, a gNB-CU-CP part 106 and a set 108 of gNB-CU-UP parts. The gNB-DUs 102 and 104 may host one or more transmitter receiver points (TRPs), which may include an Edge Node (EN), an Edge Unit (EU), a Radio Head (RH), a Smart Radio Head (SRH), etc. The gNB-DUs 102 and 104 may be configured to individually (e.g., dynamic selection) or jointly (e.g., joint transmission) serve traffic to a UE (not shown in FIG. 1). Each of F1-C interfaces is used to communicatively couple one of the gNB-DUs 102 and 104 and the gNB-CU-CP part 106. Each of F1-U interfaces is used to communicatively couple one of the gNB-DUs 102 and 104 and one gNB-CU-UP part from the set 108 of gNB-CU-UP parts. Each of E1 interfaces is used to communicatively couple the gNB-CU-CP part 106 and one gNB-CU-UP part from the set 108 of gNB-CU-UP parts. The F1-C interfaces and the E1 interfaces carry, among others, signaling for setting up, modifying, relocating, and/or releasing a UE context or radio bearers.

In multi-beam or mTRP operation, more efficient uplink/downlink beam management may allow for increased intra-cell and inter-cell mobility (e.g., L1/L2-centric mobility) and/or a larger number of transmission configuration indicator (TCI) states. For example, the TCI states may include the use of a common beam for data and control transmission and reception for UL and DL operations, a unified TCI framework for UL and DL beam indication and enhanced signaling mechanisms to improve latency and efficiency (e.g., dynamic usage of control signaling). In L1/L2-centric inter-cell mobility, each possible cell selection scenario, cell selection type, and corresponding signaling may be specified. For example, L1/L2-based cell selection or change may be applied to cell selection scenarios in RRC connected/idle mode, where the scenarios may include: (i) intra-gNB-DU cell selection, and (ii) inter-gNB-DU cell selection.

In case of lower layer mobility (i.e., the L1/L2-centric mobility) for a UE, Radio Link Monitoring (RLM) may be performed by using a set of beams of a serving (or primary) cell, whereas the UE may be also served fully or partially by using a set of beams of a non-serving (or stand-by) cell. In the embodiments disclosed herein, the RLM may refer to a mechanism for the UE to monitor a downlink (DL) quality for determining if a radio link is good enough to continue transmission. For example, the UE may monitor the DL quality based on cell-specific reference signal (CRS) to detect the DL quality for the serving cell. The RLM may be used to implement the intra-gNB-DU cell and inter-gNB-DU cell selection or change scenarios according to the L1/L2 centric mobility concept.

Although 3GPP Release 17 is planned to touch on extending the mTRP operation to support transmission and reception of multiple beams from different cells, this will be related only to those cells that belong to the same gNB-DU (i.e., the intra-gNB-DU cell selection scenario). As for the possibility of changing a serving cell of a serving gNB-DU to a new cell of another gNB-DU (e.g., via L1/L2-based mechanisms), such an inter-gNB-DU cell selection scenario will be outside the scope of 3GPP Release 17.

If a UE is configured with the mTRP operation, and if a Radio Link Failure (RLF) is decided just by performing the RLM over the serving cell, the probability of the RLF increases. At the same time, if the RLF is decided by performing the RLM over both serving and non-serving cells, the probability of the RLF decreases and mobility robustness is improved. However, in the latter case, there is a significant disadvantage that the RLM should be performed on the beams of both serving and assisting cells. This may require the UE to monitor a greater number of simultaneous radio links, which is quite expensive in nature. Moreover, a combination of the radio links of different cells may lead to confusion for serving cell re-establishment. In case of the mTRP operation, the UE may be configured to transmit and receive data from both serving and non-serving cell (which may also be called an assisting cell).

The example embodiments disclosed herein provide a technical solution that allows mitigating or even eliminating the above-sounded drawbacks peculiar to the prior art. In particular, the technical solution disclosed herein enables an efficient RLM for a UE in a mTRP scenario. For this purpose, a serving cell of a serving DU of a network node and at least one non-serving (or assisting) cell of a non-serving DU of the network node are configured for a UE. Then, the UE is informed of beams used for the serving and non-serving cells. The UE performs the RLM over the serving cell by using the beams of the serving cell. Whenever there is an RL quality degradation (which may potentially lead to an RLF) detected in the serving cell, the UE may initiate switching of the RLM from the serving cell to one of the non-serving cells by transmitting a corresponding request to the serving DU.

It should be noted that the example embodiments disclosed herein are applicable to cells configured for Inter-Cell Lower Layer Mobility (ICBM) operation or mTRP operation. The ICBM operation implies that
Multiple cells having a large overlap in configuration with the same time alignment timer are configured under ICBM.
An L1-based configuration change is not needed when the serving cell is changed to a target cell. The UE is configured to use resources/physical channels of the target cell using the configuration of the serving cell.
No Random-Access Channel (RACH) is needed upon the serving cell change.
A Medium Access Control (MAC) Control Element (CE) is used to deliver the serving cell change to the serving DU.

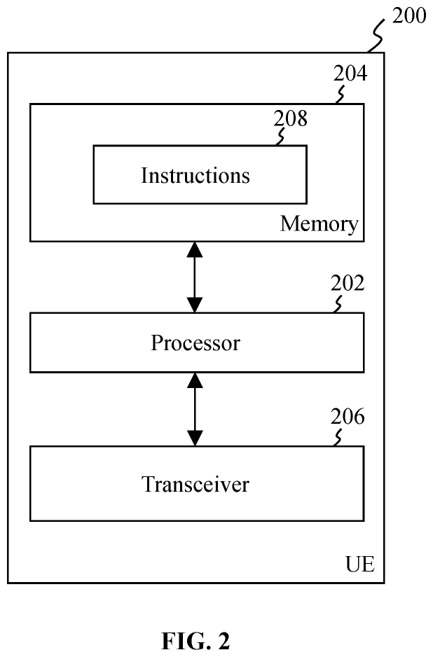

FIG. 2 shows a block diagram of a UE 200 in accordance with one example embodiment. The UE 200 is intended to communicate with a disaggregated network node (like the gNB 100) in any of the above-described wireless communication networks. As shown in FIG. 2, the UE 200 comprises a processor 202, a memory 204, and a transceiver 206. The memory 204 stores processor-executable instructions 208 which, when executed by the processor 202, cause the processor 202 to perform the aspects of the present disclosure, as will be described below in more detail. It should be noted that the number, arrangement, and interconnection of the constructive elements constituting the UE 200, which are shown in FIG. 2, are not intended to be any limitation of the present disclosure, but merely used to provide a general idea of how the constructive elements may be implemented within the UE 200. For example, the processor 202 may be replaced with several processors, as well as the memory 204 may be replaced with several removable and/or fixed storage devices, depending on particular applications. Furthermore, in some embodiments, the transceiver 206 may be implemented as two individual devices, with one for a receiving operation and another for a transmitting operation. Irrespective of its implementation, the transceiver 206 is intended to be capable of performing different operations required to perform the data reception and transmission, such, for example, as signal modulation/demodulation, encoding/decoding, etc. In other embodiments, the transceiver 206 may be part of the processor 202 itself.

The processor 202 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 202 may be implemented as any combination of one or more of the aforesaid. As an example, the processor 202 may be a combination of two or more microprocessors.

The memory 204 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 208 stored in the memory 204 may be configured as a computer-executable program code which causes the processor 202 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 204) on the fly.

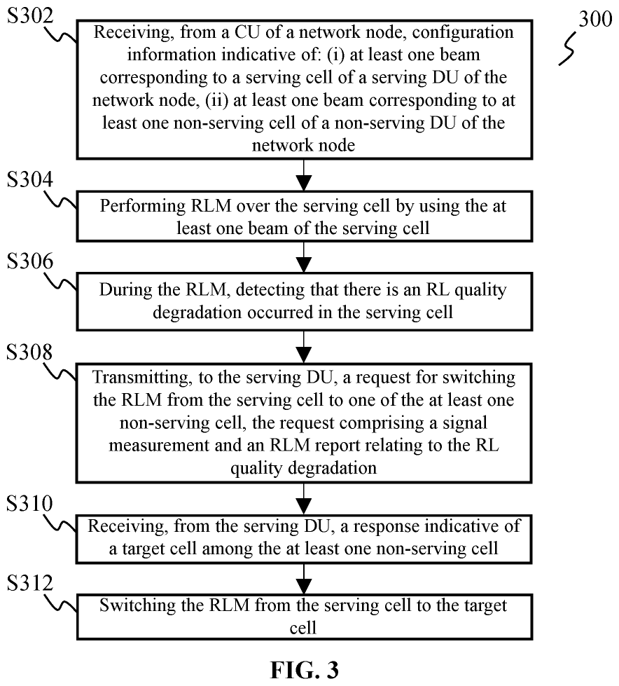

FIG. 3 shows a flowchart of a method 300 for operating the UE 200 in accordance with one example embodiment. The method 300 starts with a step S302, in which the processor 202 receives (e.g., via the transceiver 206) configuration information from a CU of the disaggregated network node. The configuration information is indicative of: (i) one or more beams corresponding to a serving cell of a serving DU of the disaggregated network node, (ii) one or more beams corresponding to one or more non-serving cells of a non-serving DU of the disaggregated network node. The configuration information may be transmitted by using a dedicated signalling (e.g., an RRC message). The method 300 then proceeds to a step S304, in which the processor 202 performs RLM over the serving cell by using the beam(s) of the serving cell. Next, the method 300 goes on to a step S306, in which the processor 202 detects, during the RLM, that there is an RL quality degradation occurred in the serving cell. The RL quality degradation may be indicative of an impending RLF in the serving cell. Further, the method 300 proceeds to a step S308, in which the processor 202 transmits (e.g., via the transceiver 206) a request for switching the RLM from the serving cell to one of the non-serving cells to the serving DU. The request comprises a signal measurement (preferably the latest signal measurement) and an RLM report relating to the RL quality degradation occurred in the serving cell. In a preferred embodiment, the signal measurement includes a Reference Signals Received Power (RSRP) and a Reference Signal Received Quality (RSRQ) and may be transmitted by using a L1-based mechanism. After that, the method 300 proceeds to a step S310, in which the processor 202 receives (e.g., via the transceiver 206), from the serving DU, a response indicative of a target cell among the at least one non-serving cell, and to a step S312, in which the processor 202 switches the RLM from the serving cell to the target cell and continue the RLM over the target cell by using corresponding one or more of the beams indicated in the received configuration information.

In one example embodiment, the configuration information may be further indicative of an RLM switching timer. In this embodiment, the method 300 may comprise an additional step, in which the processor 202 triggers the RLM switching timer upon detecting the RL quality degradation in the serving cell and transmits, in the step S308, the request to the serving DU after the RLM switching timer expires. The RLM switching timer may be implemented as a fraction of any known 5G NR timers, such, for example, as a T310 timer.

If the response is not received from the serving DU, then the processor 202 of the UE 200 may continue the RLM over the serving cell and subsequently declare an RLF in accordance with the existing procedure. This may further lead to RRC re-establishment or the transition of the UE 200 into an RRC idle state.

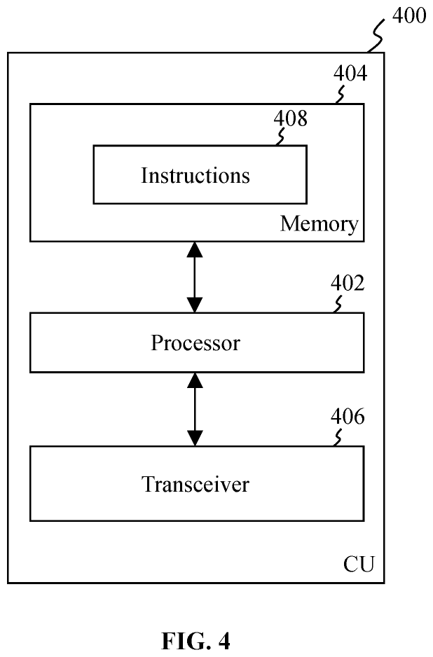

FIG. 4 shows a block diagram of a CU 400 in accordance with one example embodiment. The CU 400 is assumed to be part of the disaggregated network node (like the gNB 100) with which the UE 200 communicates in any of the above-described wireless communication networks. As shown in FIG. 4, the CU 400 comprises a processor 402, a memory 404, and a transceiver 406. The memory 404 stores processor-executable instructions 408 which, when executed by the processor 402, cause the processor 402 to implement the aspects of the present disclosure, as will be described below in more detail. It should be again noted that the number, arrangement, and interconnection of the constructive elements constituting the CU 400, which are shown in FIG. 4, are not intended to be any limitation of the present disclosure, but merely used to provide a general idea of how the constructive elements may be implemented within the CU 400. In general, the processor 402, the memory 404, the transceiver 406, and the processor-executable instructions 408 may be implemented in the same or similar manner as the processor 202, the memory 204, the transceiver 206, and the processor-executable instructions 208, respectively.

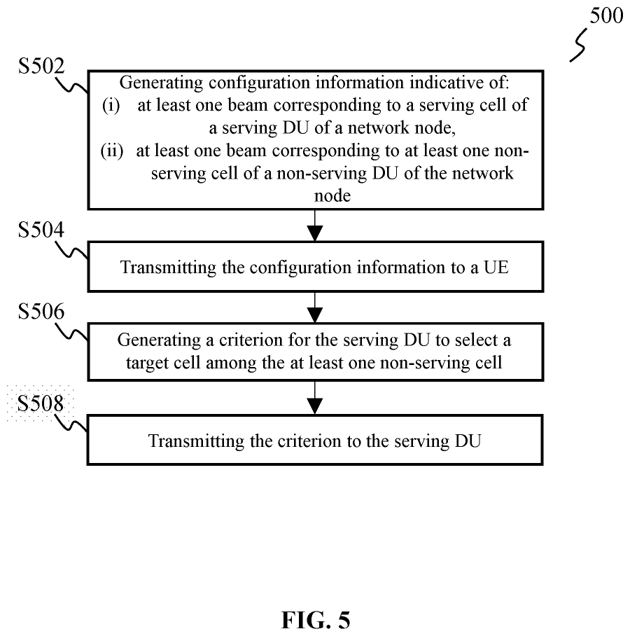

FIG. 5 shows a flowchart of a method 500 for operating the CU 400 in accordance with one example embodiment. The method 500 starts with a step S502, in which the processor 402 generates the configuration information for the UE 200. As noted above, the configuration information is indicative of: (i) the beam(s) corresponding to the serving cell of the serving DU of the disaggregated network node, (ii) the beam(s) corresponding to the non-serving cell(s) of the non-serving DU of the disaggregated network node. Furthermore, the configuration information may be additionally indicative of the RLM switching timer (e.g., a part or fraction of the T310 timer) to be used by the UE 200 when the RL quality degradation occurs in the serving cell of the serving DU. Then, the method 500 proceeds to a step S504, in which the processor 402 transmits (e.g., via the transceiver 406) the configuration information to the UE 200. Next, the method 500 goes on to a step S506, in which the processor 402 generates a criterion for the serving DU to select the target cell among the at least one non-serving cell of the non-serving DU. The criterion may be based on comparing a certain quality indicator of each of the non-serving cells to a threshold and selecting, as the target cell, that non-serving cell whose quality indicator is the best in terms of the threshold. For example, the quality indicator may be represented by an RSRP, and the criterion may be defined as follows: the target cell is that non-serving cell whose RSRP exceeds the threshold the most. The serving DU may use the criterion in response to the above-mentioned request from the UE 200. After that, the method 500 proceeds to a step S508, in which the processor 402 transmits (e.g., via the transceiver 406) the criterion to the serving DU. It should be noted that the order of the step S502-S508, which is shown in FIG. 5, is not the only possible and may be changed such that, for example, the processor 402 performs the steps S506 and S508 first and then proceeds to the step S502 and S504.

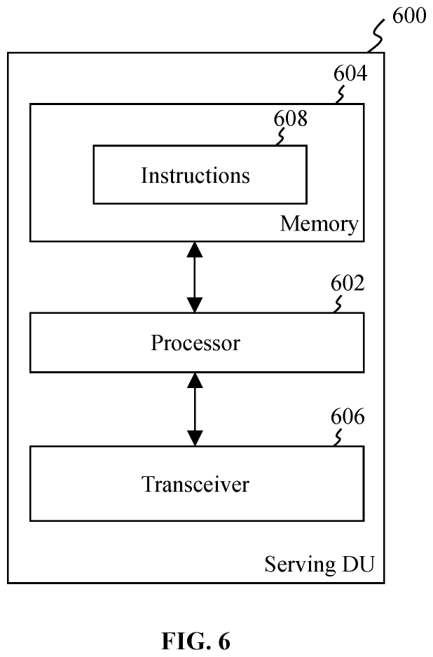

FIG. 6 shows a block diagram of a serving DU 400 in accordance with one example embodiment. The serving DU 400 is assumed to be part of the disaggregated network node (like the gNB 100) with which the UE 200 communicates in any of the above-described wireless communication networks. As shown in FIG. 6, the serving DU 600 comprises a processor 602, a memory 604, and a transceiver 606. The memory 604 stores processor-executable instructions 608 which, when executed by the processor 602, cause the processor 602 to implement the aspects of the present disclosure, as will be described below in more detail. It should be again noted that the number, arrangement, and interconnection of the constructive elements constituting the serving DU 600, which are shown in FIG. 6, are not intended to be any limitation of the present disclosure, but merely used to provide a general idea of how the constructive elements may be implemented within the serving DU 600. In general, the processor 602, the memory 604, the transceiver 606, and the processor-executable instructions 608 may be implemented in the same or similar manner as the processor 202, the memory 204, the transceiver 206, and the processor-executable instructions 208, respectively.

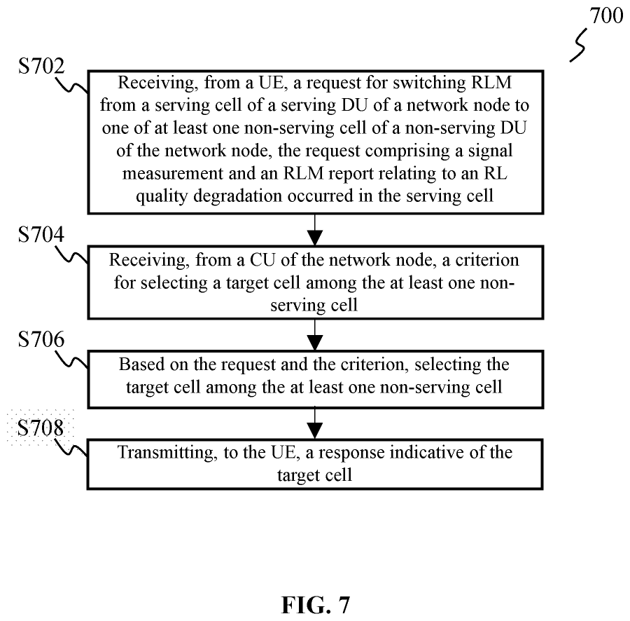

FIG. 7 shows a flowchart of a method 700 for operating the serving DU 600 in accordance with one example embodiment. The method 700 starts with a step S702, in which the processor 602 receives (e.g., via the transceiver 606) the above-mentioned request from the UE 200. The request is used by the UE 200 to perform switching of the RLM from the serving cell of the serving DU 600 to one of the at least one non-serving cell of the non-serving DU. The request may be received by using a L1-based mechanism. Then, the method 700 proceeds to a step S704, in which the processor receives (e.g., via the transceiver 606) the above-mentioned criterion for selecting the target cell from the CU 400. Next, the method 700 goes on to a step S706, in which the processor 602 uses the request from the UE 200 and the criterion from the CU 400 to select the target cell among the at least one non-serving cell. After that, the method 700 proceeds to a step S708, in which the processor 602 transmits, to the UE 200, the response indicative of the target cell. The response may be transmitted by using a MAC CE.

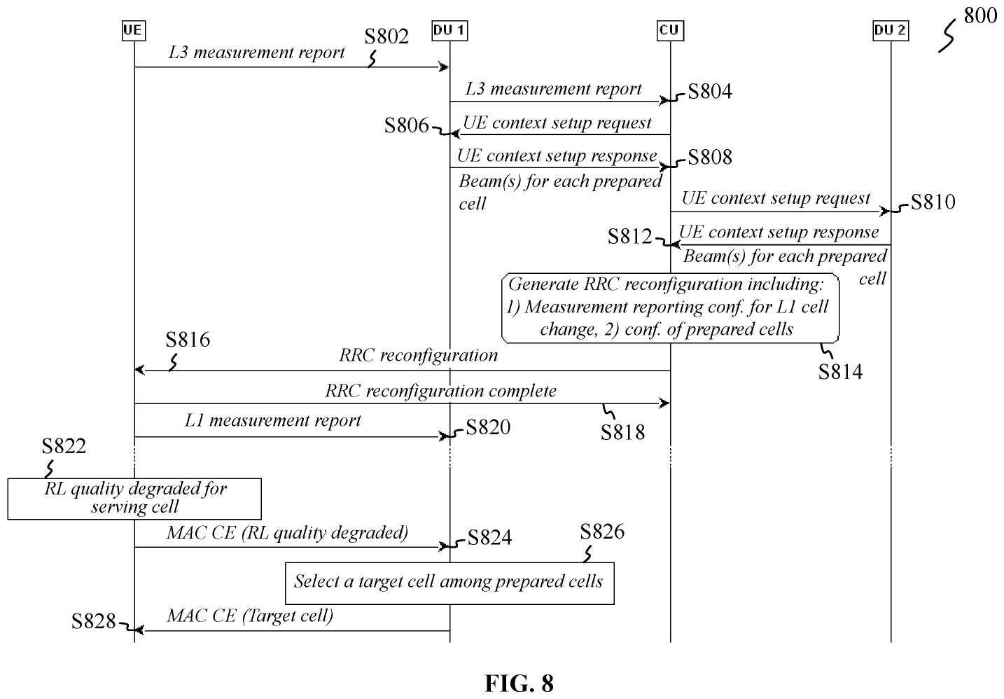

FIG. 8 shows an interaction diagram 800 that explains the interaction between a UE and logical entities of a disaggregated network node in accordance with one example embodiment. The UE may be implemented as the UE 200. The disaggregated network may be implemented as a disaggregated gNB (like the gNB 100). As follows from FIG. 8, the disaggregated network node comprises a serving DU (i.e., DU 1), a non-serving DU (i.e., DU 2), and a CU. The DU 1 may be implemented as the serving DU 600, and the CU shown in FIG. 8 may be implemented as the CU 400. Those skilled in the art would recognize that the present disclosure is not limited to the number of the logical entities shown in FIG. 800; in some other embodiments, the network node may be disaggregated such that it comprises more than two DUs, one of which may be a serving DU for the UE.

The interaction diagram 800 starts with a step S802, in which the UE transmits a measurement report to the DU 1 via a L3-based mechanism (hereinafter referred to as the L3 measurement report for short). The L3 measurement report relates to the quality of cells/beams used by the UE, and the CU uses the L3 measurement report to perform cell/beam changes, if required. In a step S804, the DU 1 forwards the L3 measurement report to the CU.

In response to the L3 measurement report, the CU sends a UE context setup request to the DU 1 and receives a UE context setup response from the DU1 in steps S806 and S808, respectively. The CU performs the same for the DU 2 in steps S810 and S812. The UE context setup includes UE-specific details from the CU to the DU 1 and the DU 2, which are used for asking for a dedicated connection for that UE and also for reserving necessary resources for further services (e.g., data transmission). The DU assigns the resources required, prepares a configuration based on that, which could be used by the UE, and sends this back to the CU in the UE context setup response. It should be noted that the steps S806-S812 may be performed in parallel, if required and depending on particular application. Moreover, each of the UE context setup responses provided by the DU 1 and the DU 2 comprises one or more beams for each prepared non-serving cell.

By using the UE context setup responses, the CU generates, in a step S814, configuration information as RRC reconfiguration which includes: 1) a measurement reporting configuration for L1-based cell change; 2) a configuration of each prepared cell (i.e., one or more beams corresponding thereto); and optionally 3) an mTRP configuration (i.e., the UE can use the cells of both the DU 1 and the DU 2). The CU transmits the RRC reconfiguration to the UE in a step S816, and the UE informs the CU of the RRC reconfiguration completion in a step S818.

Further, the interaction diagram 800 proceeds to a step S820, in which the UE periodically transmits a measurement report to the DU 1 via a L1-based mechanism (hereinafter referred to as the L1 measurement report for short). The L1 measurement report is used for the same purpose as the L3 measurement report mentioned above.

After that, the interaction diagram 800 goes on to a step S822, in which the UE performs the RLM over the serving cell of the DU 1. It is assumed that the UE detects an RL quality degradation (e.g., corresponding to an impending RLF) in the serving cell during the RLM (e.g., data reception or transmission is no longer possible in the serving cell since an RL quality has fallen below a threshold). In a step S824, the UE transmits, to the DU 1, a MAC CE comprising the L1 measurement report and an RLM report relating to the RL quality degradation. The MAC CE is considered by the DU 1 as a request for switching the RLM from the serving sell to any of the prepared cells (e.g., the cell of the DU 2). The DU 1 selects the target cell among the prepared cells in a step S826 (e.g., by using the criterion discussed above and the MAC CE from the UE). The interaction diagram 800 ends up with a step S828, in which the DU 1 transmits a responsive MAC CE indicative of the target cell to the UE.

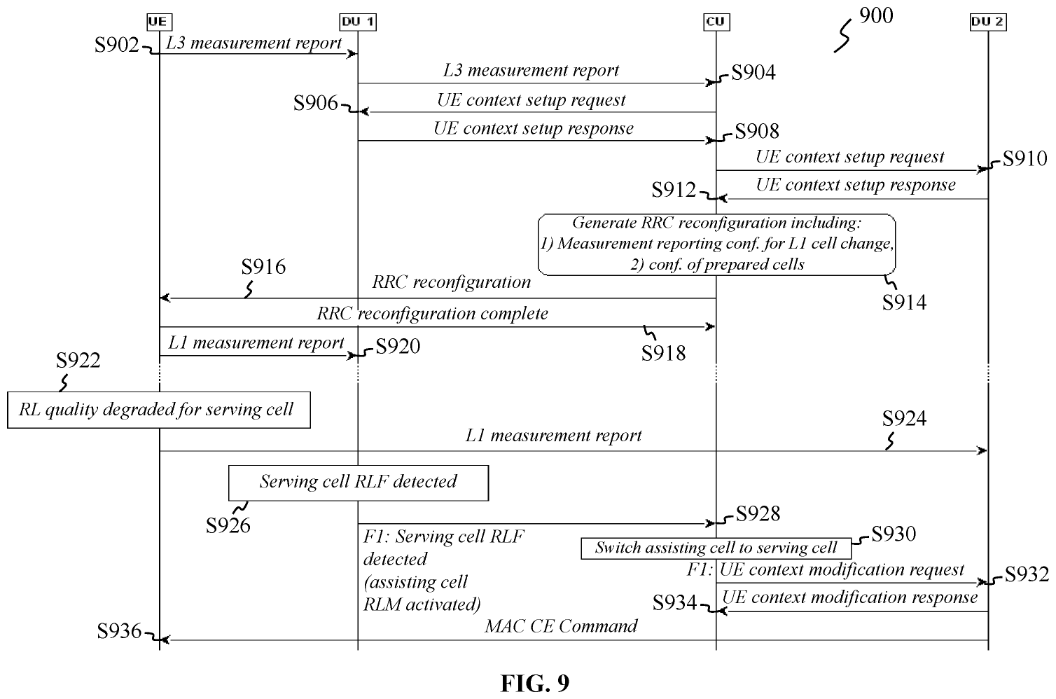

FIG. 9 shows an interaction diagram 900 that explains the interaction between a UE and logical entities of a disaggregated network node in accordance with another example embodiment. Similarly, the UE may be implemented as the UE 200, and the disaggregated network may be implemented as a disaggregated gNB (like the gNB 100). As follows from FIG. 9, the disaggregated network node comprises a serving DU (i.e., DU 1), a non-serving DU (i.e., DU 2), and a CU. Again, the DU 1 may be implemented as the serving DU 600, and the CU shown in FIG. 9 may be implemented as the CU 400.

Steps S902-S920 of the interaction diagram 900 are similar, respectively, to the steps S802-S820 of the interaction diagram 800.

At the same time, unlike the interaction diagram 800, the interaction diagram 900 implies that the UE has an mTRP configuration such that there is an assisting cell of the DU 2 whose RL is active (i.e., data transmission may be ongoing in the assisting cell as well), but the RLM is initially performed by the UE only based on the beams of the serving cell of the DU 1. In this sense, the assisting cell differs from the prepared cells mentioned above when discussing the interaction diagram 800.

As soon as the UE detects an RL quality degradation in the serving cell in a step S922, it autonomously switches the RLM from the serving cell to the assisting cell. For this purpose, the UE transmits an L1 measurement report to the DU 2 in a step S924. The DU 1 detects an RLF in the serving cell in a step S926 and informs the CU of the RLF in a step S928 by sending a corresponding MAC-CE over an F1 interface, while enabling switching the RLM from the serving cell to the target (i.e., assisting) cell. The DU 1 detects exactly the RLF for the following reason. Unless the UE reports the RL quality degradation, the DU 1 cannot detect it. In this case, it is assumed that the RL quality has degraded so fast, that the UE could not report it to the DU 1. Hence, the DU 1 may only detect the RLF in the serving cell. It should be also noted that if the RL quality degradation was reported to the DU 1, the interaction diagram 900 would convert to the interaction diagram 800. Therefore, the DU 1 may just send the MAC-CE to switch the RLM from the serving cell to the assisting cell. This MAC-CE triggers the CU to change the assisting cell to the serving cell.

In a step S930, the CU performs said switching. Then, the CU transmits a UE context modification request to the DU 2 over an F1 interface in a step S932 and receives a UE context modification response in a step S934. The interaction diagram 900 ends up with a step S936, in which the DU 2 transmits a MAC CE command indicative of a serving-to-assisting cell change to the UE.

It should be noted that each step or operation of the method 300, 500, 700, as well as the interaction diagrams 800 and 900, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 202, 402, or 602, respectively. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1-21. (canceled)

22. A User Equipment (UE) in a wireless communication network, comprising:
at least one processor; and
at least one memory including a computer program code;
wherein the at least one memory and the computer program code are configured to, with the at least one processor, cause the UE to:
receive, from a Centralized Unit (CU) of a network node, configuration information indicative of: (i) at least one beam corresponding to a serving cell of a serving Distributed Unit (DU) of the network node, (ii) at least one beam corresponding to at least one non-serving cell of a non-serving DU of the network node;
perform Radio Link Monitoring (RLM) over the serving cell by using the at least one beam of the serving cell;
during the RLM, detect that there is a Radio Link (RL) quality degradation occurred in the serving cell;
transmit, to the serving DU, a request for switching the RLM from the serving cell to one of the at least one non-serving cell, the request comprising a signal measurement and an RLM report relating to the RL quality degradation;
receive, from the serving DU, a response indicative of a target cell among the at least one non-serving cell; and
switch the RLM from the serving cell to the target cell.

23. The UE of claim 22, wherein the configuration information is further indicative of an RLM switching timer, and wherein the at least one memory and the computer program code are further configured to, with the at least one processor, cause the UE to:
trigger the RLM switching timer upon detecting the RL quality degradation in the serving cell; and
transmit the request to the serving DU after the RLM switching timer expires.

24. The UE of claim 23, wherein the RLM switching timer is less than a T310 timer.

25. The UE of claim 22, wherein the at least one memory and the computer program code are configured to, with the at least one processor, cause the UE to transmit the request by using at least one of Medium Access Control (MAC) Control Element (CE) and a Channel State Information (CSI) report.

26. The UE of claim 22, wherein the at least one memory and the computer program code are configured to, with the at least one processor, cause the UE to transmit the request by using a Layer 1 (L1) or Layer 2 (L2)-based mechanism.

27. The UE of claim 22, wherein the signal measurement comprises at least one of a Reference Signals Received Power (RSRP) and a Reference Signal Received Quality (RSRQ).

28. A Centralized Unit (CU) of a network node disaggregated in a wireless communication network into a serving Distributed Unit (DU), a non-serving DU and the CU, wherein the CU comprises:
at least one processor; and
at least one memory including a computer program code;
wherein the at least one memory and the computer program code are configured to, with the at least one processor, cause the CU to:
generate configuration information indicative of: (i) at least one beam corresponding to a serving cell of the serving DU of the network node, (ii) at least one beam corresponding to at least one non-serving cell of the non-serving DU of the network node;
transmit the configuration information to a User Equipment (UE);
generate a criterion for the serving DU to select a target cell among the at least one non-serving cell, the criterion being used if the serving DU receives a request for switching Radio Link Monitoring (RLM) from the serving cell to one of the at least one non-serving cell from the UE; and
transmit the criterion to the serving DU.

29. The CU of claim 28, wherein the configuration information is further indicative of an RLM switching timer to be used by the UE when a Radio Link (RL) quality degradation occurs in the serving cell of the serving DU.

30. The CU of claim 29, wherein the RLM switching timer is less than a T310 timer.

31. The CU of claim 28, wherein the criterion is defined as follows: an RL quality indicator for the target cell is above a threshold.

32. A method for operating a User Equipment (UE) in a wireless communication network, comprising:
receiving, from a Centralized Unit (CU) of a network node, configuration information indicative of: (i) at least one beam corresponding to a serving cell of a serving Distributed Unit (DU) of the network node, (ii) at least one beam corresponding to at least one non-serving cell of a non-serving DU of the network node;
performing Radio Link Monitoring (RLM) over the serving cell by using the at least one beam of the serving cell;
during the RLM, detecting that there is a Radio Link (RL) quality degradation occurred in the serving cell;
transmitting, to the serving DU, a request for switching the RLM from the serving cell to one of the at least one non-serving cell, the request comprising a signal measurement and an RLM report relating to the RL quality degradation;
receiving, from the serving DU, a response indicative of a target cell among the at least one non-serving cell; and
switching the RLM from the serving cell to the target cell.

33. A method for operating a Centralized Unit (CU) of a network node disaggregated in a wireless communication network into a serving Distributed Unit (DU), a non-serving DU and the CU, wherein the method comprises:
generating configuration information indicative of: (i) at least one beam corresponding to a serving cell of the serving DU of the network node, (ii) at least one beam corresponding to at least one non-serving cell of the non-serving DU of the network node;
transmitting the configuration information to a User Equipment (UE);
generating a criterion for the serving DU to select a target cell among the at least one non-serving cell, the criterion being used if the serving DU receives a request for switching Radio Link Monitoring (RLM) from the serving cell to one of the at least one non-serving cell from the UE; and
transmitting the criterion to the serving DU.

34. A computer program product comprising a computer-readable storage medium, wherein the computer-readable storage medium stores a computer code which, when executed by at least one processor, causes the at least one processor to perform the method according to claim 32.

35. A computer program product comprising a computer-readable storage medium, wherein the computer-readable storage medium stores a computer code which, when executed by at least one processor, causes the at least one processor to perform the method according to claim 33.
